(19) United States
(12) Patent Application Publication
(10) Pub. No.: US 2002/0032620 A1
(43) Pub. Date: Mar. 14, 2002

(54) Electronic network based controlled products selling and delivering system and method

(76) Inventors: Patrick H. Benz, Sarasota, FL (US); Jose A. Ors, Sarasota, FL (US)

Correspondence Address: George C. Beck, FOLEY & LARDNER, Washington Harbour, 3000 K Street, N.W., Suite 500, Washington, DC, 20007-5109, US

(21) Appl. No.: 09/776,694

(22) Filed: Feb. 6, 2001

Related U.S. Application Data
(63) Continuation of application No. 09/667,541, filed on Sep. 22, 2000.
(60) Provisional application No. 60/155,657, filed on Sep. 24, 1999.

(51) Int. Cl. G06F 17/60

(52) U.S. Cl. 705/27

(57) ABSTRACT

A method of providing controlled products requiring a prescription, such as contact lenses, and other products sold ancillary to the sale of the controlled product by a vendor to a client by using an electronic network, includes: providing an electronic network interface for a client to view information about the products in which the information is customized for each of respective licensed or authorizing professionals and clients; selecting of products by the client in accordance with the information customized for a particular professional; and providing the client the selected products in accordance with the information of the particular professional.

### CROSS-REFERENCE TO RELATED APPLICATION

This application claims the benefit of priority under 35 U.S.C. §119(e) of provisional patent application Ser. No. 60/155,657, entitled “Electronic Network Based Eye Care Products Selling and Delivering System,” filed on Sep. 24, 1999, and claims the benefit of priority under 35 U.S.C. §120 of patent application Ser. No. 09/667,541, entitled “Electronic Network Based Eye Care Products Selling and Delivering System” filed Sep. 22, 2000, the respective contents of which are explicitly incorporated by reference herein.

### BACKGROUND OF THE INVENTION

1. Field of the Invention

This invention relates generally to the field of selling and delivering controlled products, such as contact lens, and ancillary products, such as other eye care products, to clients by using a public electronic network such as the Internet. More particularly this invention relates to a method and system by which a client can directly contact a vendor of the controlled product, such as an eye care product vendor, through the internet to purchase products on similar terms as when purchasing directly from an eye care professional. As used herein, “controlled products” refers to goods or services that require a prescription or other authorization from a licensed professional. “Ancillary products” refers to goods or services that do not require authorization by a licensed professional but whose sale often accompanies the sale or provision of controlled products. It should also be noted that “authorizing professional,” “prescribing professional,” and “licensing professional,” are used interchangeably herein.

1. Description of the Related Art

Currently, purchase of eye care products, especially those requiring a prescription, are often conducted or controlled by eye care professionals. These eye care professionals include O.D's, M.D's, opticians or the like. The eye care professionals are responsible for providing a prescription for their clients and also provide eye care services related to the eye care products. For example, for the purchase of contact lenses, the eye care professionals provide both the prescription as well as the after purchase care required for a client to successfully use contact lenses without causing damage to the eyes.

A problem with this method of purchasing eye care products is that the clients are required to visit their eye care provider each time they order additional or replacement products. While this procedure may be acceptable for purchasing infrequently replaced articles such as glasses, it is very inconvenient for ordering items that need to be replaced or refilled frequently, such as disposable contact lenses. Furthermore, the necessity of making an additional visit to the eye care provider to purchase the product is an inconvenience by itself. The client is required to make transportation arrangements, take time off from work, visit the eye care professional during specified times of the day, for example, and these arrangements make the visit to the eye care professional inconvenient.

Furthermore, there is a problem with eye care product vendors directly distributing eye care products to clients. The eye care professionals are generally bypassed in this process and, therefore, have no incentive to order products that are sold by such an eye care vendor. The direct sale of eye care products to a client without the involvement of an eye care professional also runs the risk that the client does not receive the requisite eye care because a client may continue to use an older or expired prescription and thereby purchase product that is not suitable for the client. Therefore, direct purchase of products from an eye care vendor, without the involvement of an eye care professional, runs the risk of the clients receiving less than adequate eye care service even though they may be able to receive eye care products more inexpensively and more conveniently.

It will be readily understood and appreciated by those skilled in the art that these problems are similarly encountered in connection with delivery of other controlled products that require prescription on other authorization by a licensed professional.

### SUMMARY OF THE INVENTION

Therefore, it is a general objective of the invention to alleviate the problems and shortcomings identified above.

One of the objectives of one aspect of the invention is to provide a method by which controlled products and ancillary products, can be distributed by a vendor to a client by using an electronic network, while the product is sold on terms that are similar to that offered by an authorized or licensed professional.

These and other objectives are achieved by providing a method of providing controlled and ancillary products by a vendor to a client by using an electronic network, the method including the steps of: (a) providing an electronic network interface for a client to view information about the products in which the information is customized for each of respective authorizing professionals and clients; (b) selecting of products by the client in accordance with the information customized for a particular professional; and (c) providing the client the selected products in accordance with the information of the particular professional.

The method further includes a step (d) of signing up an authorizing professional, such as an eye care professional, to authorize delivery of controlled products in accordance with information customized for that professional, wherein the step (d) of signing up includes: providing, by the professional to the vendor, a client price list for products to be sold by the professional and an account for payment to be made to the professional; providing, by the professional to the vendor, a questionnaire for a new client to signup with the professional; providing, by the vendor, a customized information page accessible on the electronic network, the information page being customized for the professional; providing, by the vendor to the professional, a userid and password which allows the professional access to add, delete or modify information on the customized information page corresponding to that professional; and optionally providing by the professional to the vendor, one or more of a picture, letterhead graphics, a brief narrative of the professional and his practice.

According to one aspect of the invention, the step (a) of method described above includes the steps of: providing, a unique client id to a client by a prescribing professional; maintaining prescription and other unique information about the client provided by the prescribing professional in accordance with the client id; and displaying customized information about the authorizing professional and the client based on the client id.

According to another aspect of the invention, step (b) of the method described above includes selecting, by the client, of a product based on the displayed customized information, and providing payment information by the client for the selected products.

According to a further aspect of the invention step (c) of the method described above includes: providing from stock or ordering the selected products by the vendor; generating a receipt for the client using letterhead information of the prescribing professional; generating and sending an invoice to the prescribing professional for the charges due to the vendor for the sale of the selected products; and delivering the selected products to the client.

Another aspect of the present invention provides a computer implemented method of providing products, such as eye care products, by a vendor to a client using an electronic network, including the steps of: providing an authorizing professional a protected interface to enter and update client and pricing information for selling products; maintaining the client and pricing information entered by the professional at a processing location such that the vendor has no access to the client and pricing information entered by the professional; and transmitting order fulfillment information to the vendor by only providing the vendor with information necessary for order fulfillment.

A further aspect of the present invention includes validating order information entered by a client based on client and pricing information related to the client entered or updated by the professional; rejecting the order if the order information is invalidated based on the information entered or updated by the professional; and transmitting order fulfillment information to the vendor if the order information is valid based on the information entered or updated by the professional.

In another aspect the present invention includes providing a protected interface includes providing a password to the professional so that data protected by the password is not accessible to the vendor.

In one aspect, the present invention includes shipping products according to the order information to the client; providing an invoice to the client using the identification and pricing of the professional associated with the client; and crediting any payment received from a client to the professional.

In yet another aspect the present invention includes a computer readable data storage medium having program code recorded thereon for providing products, such as eye care products, by a vendor to a client using an electronic network, the program code includes: a first program code that provides an authorizing professional a protected interface to enter and update client and pricing information for selling products; a second program code that maintains the client and pricing information entered by the professional at a processing location such that a vendor has no access to the client and pricing information entered by the professional; and a third program code that transmits the order fulfillment information to the vendor by only providing the vendor with information necessary for order fulfillment.

In a further aspect, the present invention provides a system for providing products by vendor to a client using an electronic network, including: an authorizing professional interface unit that provides a protected interface for a professional to enter and update client and pricing information for selling products; and a data processing unit that (i) maintains the client and pricing information entered by the professional such that a vendor has no access to the client and pricing information entered by the professional; and (ii) transmits order fulfillment information to the vendor by only providing the vendor with information necessary for order fulfillment.

In a further aspect, the system collects and manages payments from the client on behalf of the professional.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a diagram showing the components of a typical general purpose computer system connected to an electronic network.

FIG. 2 is a flow diagram illustrating the initial steps of an authorizing professional, such as an eye care professional interacting with the vendor to set up to sell controlled products, such as contact lenses, and ancillary products, such as cleaning solution, through the vendor's website.

FIG. 3 is a flow diagram illustrating the subsequent steps of an eye care professionals interaction with the eye care vendor to administer the information that is customized for that eye care professional.

FIG. 4 is a flow diagram that illustrates the steps of the interaction of a client with the web site provided by the eye care vendor.

FIG. 5 is a flow diagram that illustrates the steps of the transaction flow after a purchase order has been placed by a client.

FIG. 6 is a block diagram illustrating another preferred embodiment of the present invention.

### DESCRIPTION OF THE PREFERRED EMBODIMENT(S)

The following describes, by way of example, embodiments of the invention that relate to delivery of eye care products that require a prescription, such as contact lenses. It will be appreciated that the invention may also be applied to the delivery of other controlled products whose delivery required authorization by a licensed professional, for example, through prescription.

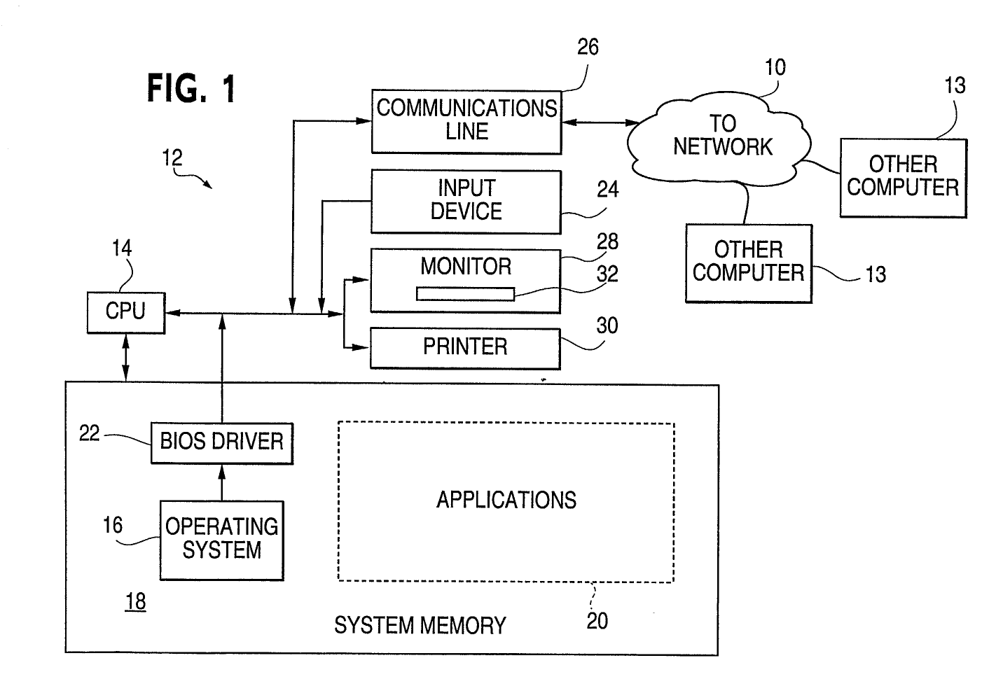

With reference to the figures, FIG. 1 is a diagram showing the components of a general purpose electronic network 10, such as a computer network. The computer network can be a public network, such as the Internet. As shown in FIG. 1, the computer system 12 including a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork such as the Internet.

One skilled in the art would recognize that the above describes a typical computer system connected to an electronic network. It should be appreciated that many other similar configurations are within the abilities of one skilled in the art and it is contemplated that all of these configurations could be used with the method of the present invention. Furthermore, it should be appreciated that it is within the abilities of one skilled in the art to program and configure a computer system to implement the method steps of the present invention, discussed further herein.

Furthermore, the present invention contemplates providing computer readable data storage means with program code recorded thereon for implementing the method steps described further herein. One skilled in the art would be able to develop the required program code based on the disclosure contained herein.

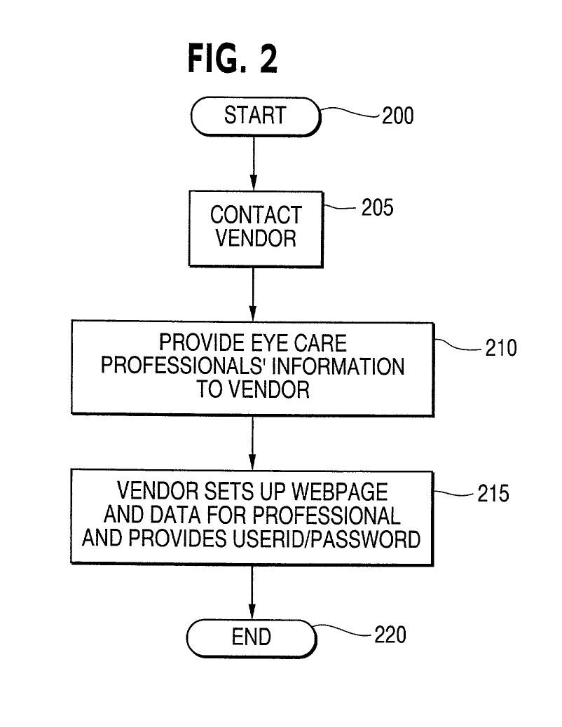

FIGS. 2-5 are flowcharts showing the method steps of one preferred embodiment of the present invention. FIG. 2 shows the steps of a typical interaction between an eye care product vendor and an eye care professional that enables the eye care product vendor to sell products on terms that are similar to that of the eye care professional. The preferred embodiment of the present invention contemplates that the sale of contact lenses as the eye care product. Furthermore, throughout this specification eye care professionals, eye care providers, and eye care practitioners are interchangeably used and have the same meaning with respect to the present invention.

It is also to be understood that the present invention also contemplates the sale of other products by the vendor including products that may not need a prescription from a licensed professional. That is, the present invention contemplates that other products, including both those requiring prescriptions and those not requiring prescriptions, are sold. Therefore, for example, the present invention contemplates that products that are sold as ancillary to a purchase of a contact lens, such as, cleaning solutions and rinsing solutions can also be sold on terms that are similar to that sold by the prescribing eye care professional using the methods and system according to the present invention. More generally it applies to other products that may be sold ancillary to the sale of a controlled product requiring a prescription or other authorization by a licensed professional.

In the initial interaction between the eye care professional and the eye care vendor shown in FIG. 2, the eye care professional contacts the eye care vendor in step 205. This contact can be made using traditional means such as the telephone, postal mail, electronic mail, or through a link provided in a web page in a web site of the eye care vendor. It is to be understood that the initial interaction steps refer to the steps required to be completed before an eye care professional is set up to sell product from the eye care vendors website. In practice, these initial steps can be completed in one or more interactions between the eye care vendor and the eye care professional.

It should be understood that the preferred embodiment of the present invention contemplates the use of a computer system hosting a Web site provided by the eye care vendor on the World Wide Web (WWW) on the Internet. The World Wide Web is a network of documents that are linked together on the internet using by using a linking protocol, such as the http, and these documents are created using a protocol language such as the HTML or more generically, the SGML. However, the present invention also contemplates that the information can be provided on other private or public networks instead using other interface as long as the clients and the eye care professionals are able to interactively access the information provided on this private or public network by the eye care vendor.

Furthermore, it is to be understood that the vendor, for example, the eye care vendor according to the present invention, includes a single vendor or a group of vendors that provide the eye care products using methods and systems of the present invention. It should also be understood that the Web site according to the present invention is logically provided by the eye care vendor. Physically, the Web site and other data processing resources, according to the present invention, can be provided by a third party computer services (or solutions) provider. Such computer service providers include, without limitation, web hosting service providers, system integrators, application service providers, computer outsourcing companies, or any combination of these computer service providers. Furthermore, the eye care provider may also provide some of the data processing services in combination with one or more of the third party computer service providers.

In step 210, the eye care professional provides the eye care products vendor with the information to establish a eye care professional as a provider of eye care products in accordance with the present invention. The information that is provided by the eye care professional includes, for example, his name and address, and a price list of the products that will be sold by the eye care professional. In the preferred embodiment, this list of products only includes products that are sold by the eye care vendor from either the eye care vendors stock or from the eye care vendors regular suppliers. However, it is contemplated that the eye care products sold could include products that are not sold regularly by the eye care vendor and could include products that could be ordered by the eye care vendor from other suppliers.

Other information provided by the eye care professional, for example, include a short description of the eye care professional, his practice, a photograph of the eye care professional, directions or other access information to the eye care professional, marketing tools of the eye care professional such as special discounts and/or new products. The eye care professional may also provide information that can be used to schedule appointments with the eye care professional. This scheduling information can be as simple as days/times that are available or a link or a data feed from a database or calendaring application maintained by (or on behalf of) the eye care professional that provides information on available days/times for scheduling appointments. This information is used for customizing the web page of the eye care professional and may also be used for marketing purposes to benefit the eye care professional. In one aspect of the present invention, the scheduling information provided by the eye care professional can be used to provide an interface to the clients to schedule appointments with their eye care professional. The interface can interact with a calendaring or other application of the eye care professional to update the eye care professional's appointment schedule in real time or even in a batch mode.

The eye care professional also provides the eye care vendor in step 210 with information on his account so that money due to the eye care professional can be automatically credited to his account. Therefore, this account could be a bank account or a merchant account for credit card payments, such as that used by Visa, MasterCard, American Express or other credit card providers. Therefore, the preferred embodiment of the present invention contemplates that all payments by a client is directly credited to the account of the eye care professional. Therefore, the flow of money is also handled in the same manner as if the eye care professional sold the eye care products directly to the client.

Thereafter, the eye care professional is separately invoiced by the eye care vendor for the money that is due to the eye care vendor for the purchase of the eye care product by the client. The money charged by the eye care vendor to the eye care professional can be fixed by contract on either a fixed price per unit basis or include a sliding discount based on the volume of total product sold by the eye care professional. Furthermore, the discount can also be varied based on the types of products sold by the eye care professional. The eye care professional can be invoiced either on a transaction by transaction basis or on a periodic basis, such as, for example, on a weekly or monthly basis. The client is mailed a receipt on behalf of the eye care professional, for example, by generating or using a letter head of the eye care professional so that it appears to the client that his transaction is performed with the eye care professional. In addition, client gains the benefit of the transaction being performed conveniently using the Web site or other network accessible computer interface provided by the eye care vendor.

Other optional information that can be provided by the eye care professional includes an estimate of the sales volume of the different eye care products the eye care professional expects to sell. This information would assist the eye care vendor to better manage the inventory and is particularly useful if the eye care professional expects to sell unusually high volumes of certain products. Providing this information is also beneficial to the eye care professional because it results in better inventory management and potentially faster service to his clients.

In step 215, the eye care vendor completes the processing at his website to set up a eye care professional for selling eye care products through the website. This step includes actually providing a web page customized to provide the information specific to the eye care provider. The customized web page includes information specific to the eye care provider, such as, name, address, and photograph (if provided). The web page also displays the list of products sold by the eye care professional together with the pricing for the products customized for the eye care provider. The customized pricing could include a fixed price per product or a price that varies the quantity purchased. In an alternative embodiment, the price of the products sold could be varied based on each client who accesses the eye care providers web page. To facilitate this client based pricing, for example, each client could be assigned a classification code so that the prices displayed to the client would vary with the clients classification.

Finally, in step 215, the eye care provider is provided with an unique userid (or PIN) and password by which the eye care provider can access the vendors web site and is able to access the custom information relating to the eye care provider. The password provided to the eye care professional can be changed by the eye care provider. It should be noted that the practitioner may be provided a PIN and a password. Upon accessing the eye care provider's section of the Web site, the practitioner can change his password to ensure privacy of the practitioner's data from the eye care vendor(s).

Therefore, the eye care provider can access the Web site through the userid/password to add, change or modify his custom information on the web site. The eye care professional can, therefore, alter his prices at any time. Furthermore, the eye care professional can also add a client to the system by providing the client with a unique client ID and associating the client's information with the client ID. The typical client information that can be associated with the client includes the prescriptions for the client so that the prescriptions (with an expiry date) are available in the system. In the preferred embodiment, the system is configured so that the products are not shipped out based on an expired prescription. If the client logs in to the web site and attempts to purchase products based on an expired prescription, the client is informed that his prescription has expired and is provided with information to contact the eye care provider to update his prescription. In an alternative embodiment, the prescription expiry date is not checked by the system and the client can order product based on an older prescription.

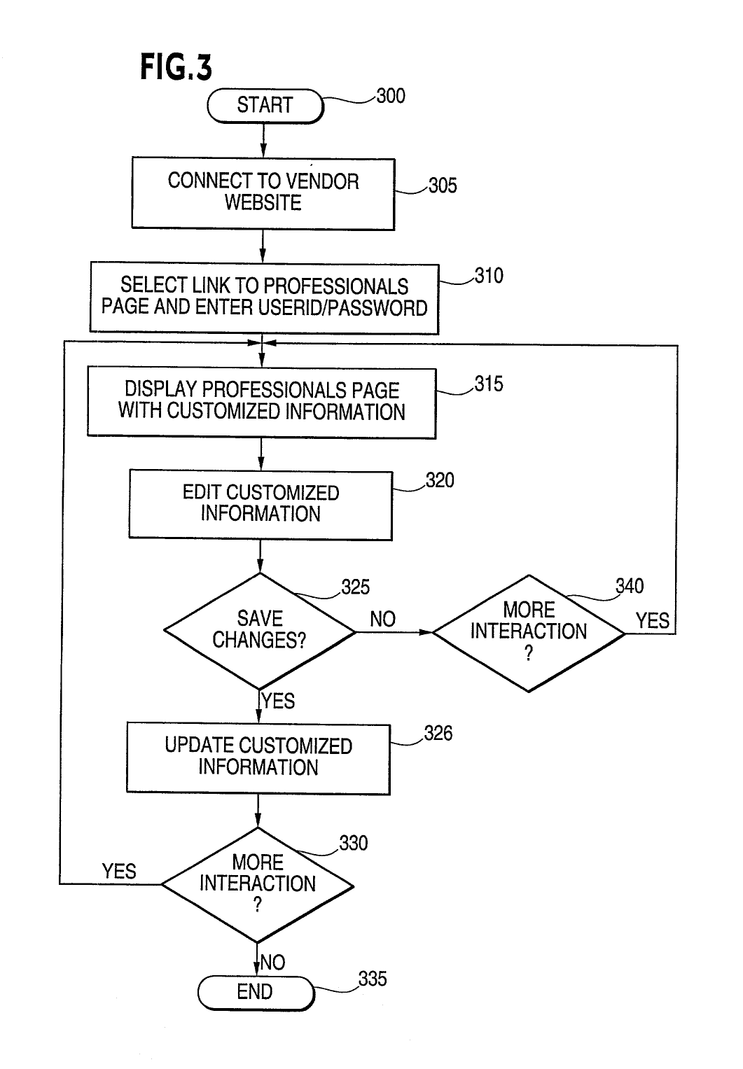

FIG. 3 is flow diagram that describes a typical interaction of the eye care professional after the eye care professional has been successfully set up to sell product over the eye care vendor's Web site. In steps 305 and 310, the eye care professional connects to the Web site and selects a link for eye care professionals. The system then requests the userid and password of the eye care professional and verifies the userid and password of the eye care professional. The eye care professional can change the password if desired.

On successful verification, the system displays a web page that is customized with the information for that eye care provider in step 315. The eye care professional has several options available to him at this point. These options are easily implemented, for example, by using hyperlinks to specific web pages.

Using one of the options, the eye care professional could add a new client in step 320 by providing the prescription information for the client and using the system to generate a unique client ID (with or without an optional password for the client) for that client. In addition, the eye care professional could add other optional information about the client, such as, for example, his name, address, the date of his last visit to the eye care professional. The eye care professional could also delete or modify an existing clients information in step 320. Information that could be modified include, for example, the expiry date of the prescription, the address of the client, or the date of the clients last visit to the eye care professional.

In step 320, the eye care professional could also add, delete or modify his pricing information including the products being sold by the eye care professional through the eye care vendor's web site. In addition, the eye care professional has the option of modifying his personal information that is displayed on the web site. In step 325, the system confirms that the eye care professional wants to save his changes. If yes, it saves the changes in step 326 and proceeds to step 330 to determine if the eye care professional has completed his interaction. If not, the system returns to step 315 to display the web page customized with the information of the eye care professional, otherwise the system exits at step 335. In step 325, if the eye care professional chooses not to save his changes, the system proceeds to step 340 to determine if the eye care professional desires further interaction. If yes, the system proceeds to step 315, otherwise, the system exits at step 335.

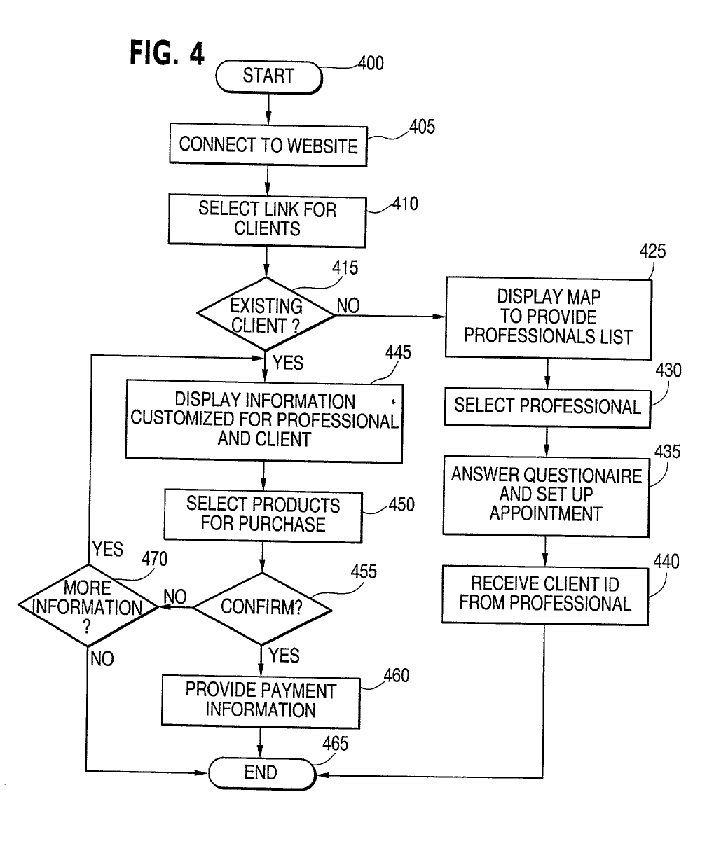

FIG. 4 traces a typical interaction between a client and the eye care provider's web site. In step 405, the client connects to the web site of the eye care providers by using a software tool that enables the client to connect to the web site. Such software tools are commonly called WWW browsers and are provided commercially by a number of vendors, such as the Microsoft provided Internet Explorer and America Online provided Netscape browser. In the preferred embodiment, the client uses a commercially provided browser to connect to the web site. However, in an alternative embodiment, the client could use a custom browser or connectivity tool to connect to the Web site or information interface provided by the system according to the present invention.

Thereafter, in steps 410 and 415, the client selects a link for an existing client if the client has previously been provided a client ID by a participating eye care professional. If not, the client is provided, in step 425, with a drill down geographical map or a data input box for a zip code so that the client can be provided with a list of participating eye care providers in his vicinity. Thereafter, the client can peruse the web pages of the participating eye care providers in step 430 to select an eye care provider of interest. The client can then fill up a questionnaire provided by the particular eye care provider and set up an appointment with the eye care provider in step 435.

In step 440, after the client has interacted with the eye care provider, the client is provided with an unique client ID. The eye care provider also enters the relevant client information in the web site of the eye care provider. As mentioned earlier, exemplary information about the client that the eye care provider enters include, the client ID, name and address of client, prescription information, and a pricing classification code if the client is to be entitled to a special price different from the standard price of the eye care provider. Furthermore, the client may have the option of changing the client password if one has been provided.

In step 445, an existing client, whose client ID has been verified is displayed a web page customized for the eye care provider that provided the client ID to the client. At this time, the web page may also be optionally customized for the client. For example, any special pricing to be displayed based on the client ID is also displayed at this point. In step 450, the client selects the products he wishes to purchase. In the preferred embodiment, the system verifies if the purchase order is valid by verifying, for example, that the client has a valid and unexpired prescription for the product that he is seeking to purchase. Once the purchase products are verified the client is displayed a confirmation screen in step 455. If the client confirms his purchase, the client is requested to provide his payment information in step 460 and the interaction is terminated at step 465. If however, the client chooses not to confirm his purchase in step 455, the client is offered the choice of being displayed more information in step 470. If the client chooses to receive more information, the system proceeds to step 445 to display information to client customized by the eye care provider and the client. If not, the interaction is terminated at step 465.

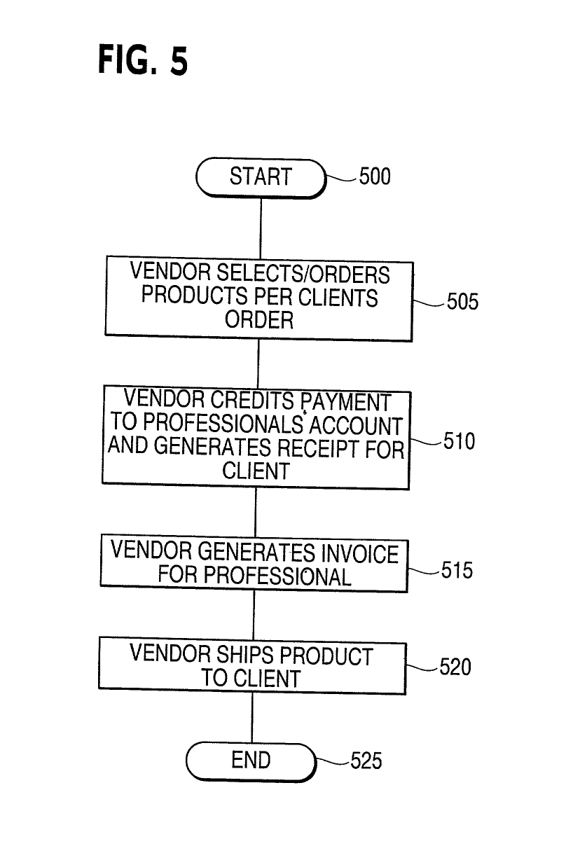

FIG. 5 is a flow diagram that shows the steps of a preferred embodiment of the transaction flow after a purchase order has been placed by a client using the Web site interface provided by the eye care vendor. In step 505, the vendor selects or orders the products that have been purchased by the client. If the products are stocked by the eye care vendor, the eye care vendor may supply the products from its own stock. If not, the vendor arranges to procure the required goods from other appropriate suppliers.

In step 510, in the preferred embodiment, the vendor credits the account of the eye care provider with the full amount of the payment received from the client. Therefore, the eye care provider receives the payment from the client in the same manner as if the eye care provider had directly sold the product to the client. Thereafter, in step 515, the vendor generates an invoice to bill the eye care provider for the cost of the product shipped out to the client on behalf of the eye care provider. The vendor ships out the product to the client in step 520 to complete the transaction flow in step 525.

It should be noted that alternate payment mechanisms can be used in step 510. For example, in an alternate embodiment, the eye care vendor can invoice the eye care provider on a periodic basis. That is, the eye care provider can generate a cumulative invoice on a weekly or monthly basis for all the products sold on behalf of a particular eye care provider. In another embodiment, the eye care vendor can deduct their cost and transfer the net proceeds to the eye care provider. Finally, a combination of these payment mechanisms may be used so that the different payments mechanisms may be implemented for different eye care vendors.

In one preferred embodiment of the present invention, the vendor sets up the web page and stores the data of the eye care professional in such a manner that the vendor does not have the authority (or access) to change any of the data relating to the eye care professional or the client. This can be implemented by the vendor contracting the eye care products selling and distribution system to a third party so that sensitive or client (patient) and/or the eye care professional's data cannot be changed by the vendor.

In another preferred embodiment of the invention, the client (or patient) is provided with a password in addition to the client ID (or PIN) such that the eye care vendor has access to certain information of the client based on the client ID but does not have access to other client information or the client's password. Therefore, the present invention provides that the eye care vendor has access to sufficient information regarding the eye care professional and the client to fulfil and administer purchase of eye care products by the clients from their eye care professional while sensitive or other private information cannot be accessed or changed by the eye care product vendor.

Examples of data that can be accessed by the eye care vendor include, for example, practice/practitioner profile, address, eye care practitioner or client userid (or PIN), as well as data required to fulfill an order as well as complete the payment flow after an order has been shipped out.

Examples of data that the eye care vendor cannot access include: (i) general patient (or client) information such that when a client reorders from the Web site, the eye care vendor may only be provided the client name, shipping address, products ordered, and price and payment details; (ii) eye care products pricing; (iii) prescription related information; (iv) limits on maximum products that can be ordered.

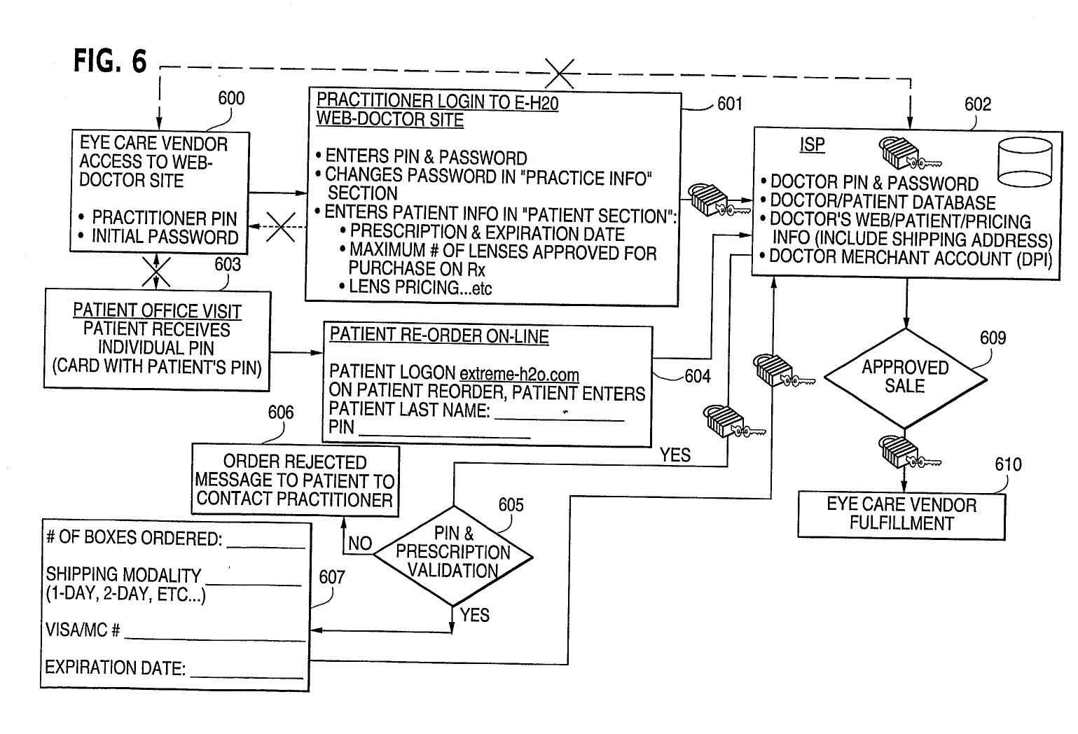

FIG. 6 is a block diagram illustrating the components of another preferred embodiment of the present invention in which the privacy of the eye care professional's and the client's data are protected from unauthorized access by the eye care vendor as significant components of the system are provided by a third party computer services provider. In block 600, the eye care vendor accesses a web-doctor interface site to set up a eye care provider with an userid (or PIN) and an initial password. The web-doctor interface site may be provided or managed by the third party computer services provider.

Thereafter, the eye care provider accesses the web-doctor interface site in block 601 so that the eye care provider can change their password and, thereby, prevent the eye care vendor from accessing any information that is protected by the eye care provider's password. Of course, the eye care vendor may still have limited access to the web-doctor interface site to access or change certain information related to eye care provider that is not password protected or may only be changed by the eye care vendor. For example, the eye care vendor may have access to the web-doctor interface site to disable an eye care providers access to the system, for example, if the eye care provider is delinquent in making payments to the eye care vendor. Alternatively, the eye care vendor may have access to disable the eye care provider from adding new clients under certain circumstances which may be agreed to in advance by all the participants in the system of the present invention.

Block 602 represents the computing (including data processing and storage) services provided by a third party computing services provider as discussed earlier. Some of the information that may be stored by the third party computing services provider include, for example, the eye care professionals'userids and passwords, the client database for information related to the clients of each of the eye care professionals, the eye care professionals customized data including prices, discounts, shipping information for both the eye care professionals and the clients, and payment processing details for receiving payments from and sending client payments to an eye care provider. In addition, the computing services provided by the third party computing services provider includes software, hardware, and networking components to implement the system according to the present invention as would be understood by those skilled in the art.

Blocks 603 and 604 depict the client related functionality provided by the system according to the present invention. Therefore, in block 603 the client receives an userid (or PIN) together with an optional password from the eye care provider who sets up the client information in the system. Some of the additional client related information that can be provided by the eye care provider includes, for example, prescription information (including expiry dates), pricing information including any special discounts, quantity limitations, payment information, and shipping information.

The client can then access the system in block 604 to order eye care products using an order interface provided by the system according to the present information. The third party computing services provider provides the software functionality that validates the order information against the criteria that may have been set up by one or more of the eye care professional, the eye care vendor, and/or the client himself. Accordingly, if the order is not validated in step 605, the client is provided with a notification in step 606 that his order was rejected. At this stage, the reason for the rejection may be provided or the client may be instructed to contact the eye care provider to determine the cause of the rejection. In such a situation, the eye care provider is provided a notification of the rejection together with the reason(s) for the same.

If the order is accepted in step 605, block 607 provides the functionality for order details, such as shipment and payment details, to be provided by the customer for onward processing by the system according to the present invention. Once the order has been accepted in step 609, the system 602 provided by the third party computing services provider generates an approved sale and provides necessary order fulfillment information to the eye care vendor in block 610. For example, in one embodiment, the eye care vendor is only provided with ordered products and shipping information so that the ordered products can be shipped to the client by the eye care vendor. The eye care vendor may ship the products with an invoice that contains the pricing and logo of the eye care professional whose client is shipped the ordered products. Any payments made by the client are directly credited to the eye care professionals account by using, for example, the eye care professionals merchant account. The eye care vendor then, preferably, periodically bills the eye care professional for all shipments to the clients of the eye care professional and provides a detailed shipment list including, for example, name and addresses of the clients, the dates of ordering and shipping, the pricing information, and any other information that may be agreed to by the eye care professionals and the eye care vendor. Therefore, this embodiment of the present invention provides additional security and privacy for information related to the eye care professionals and their clients or patients while providing the eye care vendor sufficient information for order fulfillment and processing the transactions including allocating payments.

In general, some of the advantages to a provider of controller products, such as eye care products, of the selling and processing system as provided by the present invention include: (i) a simple way is provided for new clients to find out about the provider and to schedule an initial or a subsequent appointment; (ii) a direct way to screen the new clients by effectively using the interactive questionnaire; (iii) a simple and effective way to provide controlled products, such as lenses to clients; (iv) a cost effective way to ship the client's orders through the vendor while receiving payment directly into the account of the provider; and (v) a unique way of restricting client access to data on the website by using the unique client ID. Other benefits to the providers include (i) reduced or no inventory cost; (ii) continued profit as long as a patients prescription is valid; (iii) no shipping costs; (iv) no staff costs associated with filling reorders; (v) no collection costs; (vi) better retention of clients; and (vii) better control of client's health by reducing the probability that the clients would order products using expired prescriptions or the like.

In addition, the vendor benefits by selling products on behalf of all the participating providers. Finally, the client benefits because his products are purchased under the control of a qualified professional and furthermore, the client can interact more easily with the professional by using the website. Also, the client receives products shipped directly to him and thus avoids the inconvenience of visiting the eye care professional to collect reorders products.

Other embodiments of the invention will be apparent to those skilled in the art from a consideration of the specification and the practice of the invention disclosed herein. It is intended that the specification be considered as exemplary only, with the true scope and spirit of the invention also being indicated by the following claims.

What is claimed is:

1. A computer implemented method of providing a controlled product, whose purchase requires authorization by a professional, the method comprising:
(a) providing an electronic network interface for a client to view information about the controlled product in which the information is customized for each of respective professionals and clients;
(b) receiving the client's selection of the controlled product in accordance with the information customized for a particular professional; and
(c) providing the client the selected controlled product in accordance with the information of the particular professional.

2. The computer implemented method according to claim 1, further comprising providing the client with a client userid or password restricting access to that client's information.

3. The computer implemented method according to claim 2, further comprising providing the professional with a userid or password restricting access to that professional's information and to a subset of client information of clients associated with that professional.

4. The computer implemented method according to claim 1, further comprising registering the particular professional to provide controlled products using the electronic network in accordance with information customized for the particular professional, wherein registering includes
the particular professional providing a client price list for the controlled products to be sold and an account for payment to be made to the professional,
the particular professional providing a questionnaire for a new client to submit,
generating a customized information page accessible on the electronic network, the information page being customized for the professional, and
providing a professional userid and password which allows the professional access to add, delete or modify information on the customized information page customized for that professional,

5. The computer implemented method according to claim 4, wherein registering further comprises the professional providing one or more of a picture, letterhead graphics, a brief narrative of the professional and the professional's practice.

6. The computer implemented method according to claim 4, further comprising the steps of:
providing a unique client userid to a client;
maintaining client specific information in association with the client userid; and
restricting access to the client specific information based on the client userid.

7. The computer implemented method according to claim 6, wherein receiving the client's selection of the controlled product comprises:
displaying customized information relating to the controlled product for selection of the controlled product by the client; and
receiving payment information from the client for the selected controlled product.

8. The computer implemented method according to claim 6, further comprising:
providing from stock or ordering the selected controlled product by a vendor;
generating an invoice for the client using information of the prescribing professional;
generating and sending an invoice to the prescribing professional for the charges due to the vendor for the sale of the selected controlled product; and
delivering the selected controlled products to the client.

9. The computer implemented method according to claim 1, further comprising using the electronic network interface to provide information to a client about ancillary products that are ancillary to the controlled product.

10. The computer implemented method according to claim 9, further comprising:
receiving selection of ancillary products from the client; and
providing the client the selected ancillary products.

11. A computer implemented method of providing controlled products by a vendor to a client using an electronic network, comprising:
providing a protected interface for a professional to provide and update client information and controlled products information for selling the controlled products;
maintaining the client and controlled product information such that the vendor has restricted access to the client and controlled products information entered by the professional; and
transmitting necessary order fulfillment information to the vendor.

12. The computer implemented method of providing eye care products according to claim 11, further comprising:
validating the order fulfillment information entered by a client based on client information and controlled products information provided by the professional or rejecting the order fulfillment information based on the client information or the controlled products information provided by the professional; and
transmitting the order fulfillment information to the vendor if the order fulfillment information is validated.

13. The computer implemented method according to claim 11, wherein providing a protected interface includes providing a password to the professional so that data protected by the password is restricted from the vendor.

14. The computer implemented method according to claim 11, wherein the client information provided by the professional includes prescription information and an expiry date of prescription.

15. The computer implemented method according to claim 11, wherein the controlled products information provided by the professional includes pricing information, discount information, and payment information.

16. The computer implemented method according to claim 11, wherein the order fulfillment information transmitted to the vendor includes types and quantities of controlled products ordered, prices for the controlled products ordered, and client and shipping information.

17. The computer implemented method according to claim 11, further comprising:
shipping controlled products, according to the order fulfillment information, to the client;
providing an invoice to the client using the client information and the controlled products information provided by the professional associated with the client; and
crediting any payment received from the client to the professional.

18. The computer implemented method according to claim 17, further comprising periodically invoicing the professional for all controlled products shipped to clients of that professional.

19. The computer implemented method according to claim 11, further including the step of interactively receiving order information from a client, wherein the order fulfillment information is derived from the order information received from the client and the client information and the client products information provided by the professional.

20. A computer readable data storage medium having program code recorded thereon for providing controlled products by a vendor to a client using an electronic network, the program code comprising:
a first program code that provides a licensed professional a protected interface to provide and update client information and controlled products information for selling the controlled products;
a second program code that maintains the client and controlled products information entered by the professional such that a vendor has restricted access to the client and controlled products information entered by the professional; and
a third program code that transmits the necessary order fulfillment information to the vendor.

21. The computer readable data storage medium according to claim 20, wherein the first program code includes program code that provides a password to the professional so that data protected by the password is restricted from the vendor.

22. The computer readable data storage medium according to claim 20, further comprising:
a fourth program code that generates shipping information, for the controlled products, according to the order fulfillment information;
a fifth program code that generates an invoice to the client using client information and controlled products information provided by the professional associated with the client; and
a sixth program code that credits any payment received from the client to the professional.

23. The computer readable data storage medium according to claim 22, further comprising:
a seventh program code that periodically generates an invoice to the professional for all controlled products shipped to clients of that professional.

24. A system for providing controlled products by a vendor to a client using an electronic network, comprising:
a professional interface unit that provides a protected interface for a licensed professional to provide and update client information and client products information for selling the controlled products; and
a data processing unit that:
maintains the client and pricing information entered by the professional such that the vendor has restricted access to the client and controlled products information provided by the professional; and
transmits necessary order fulfillment information to the vendor.

25. The system according to claim 24, wherein the electronic network is the Internet.

26. The system according to 24, wherein the professional interface unit provides a password protected interface for the professional such that data protected by the password is restricted from the vendor.

27. A system for providing controlled products by a vendor to a client using an electronic network, comprising:
means for providing an authorized professional a protected interface to provide and update client information and client products information for selling the controlled products;
means for maintaining the client and controlled products information entered by the professional such that a vendor has restricted access to the client and controlled products information entered by the professional; and
means for transmitting necessary order fulfillment information to the vendor.
